(19) United States
(12) Patent Application Publication
(10) Pub. No.: US 2012/0018057 A1
(43) Pub. Date: Jan. 26, 2012

(54) SURFACE LAYER STRUCTURE OF A SILVER ARTICLE AND FORMING METHOD THEREOF

(76) Inventor: KUANG-SHI KUO, TAIPEI COUNTY (TW)

(21) Appl. No.: 12/898,932

(22) Filed: Oct. 6, 2010

(30) Foreign Application Priority Data
Jul. 21, 2010 (TW) 099213940

(51) Int. Cl. C22C 5/06; G04B 47/04; C21D 1/26

(52) U.S. Cl. 148/518; 148/565; 148/678; 148/430; 368/285

(57) ABSTRACT

A surface layer structure of a silver article and a forming method thereof. The silver article is a decoration made of a silver metal body (or silver alloy body) or a silver decoration body such as in the form of a sheet. After the silver metal body is formed, at least a part of the surface of the silver metal body is heated to a recrystallization temperature to form a recrystallized surface layer. Accordingly, the residual stresses of the silver metal body are eliminated and the malleability thereof is enhanced. The crystalline grains of the recrystallized surface layer can regrow to present the specific qualities of cubic lattices. The recrystallized surface layer can be further processed by fine electrolysis to enhance the clearness and brilliance of the recrystallized surface layer. The recrystallized surface layer can be further electroplated with a colored electroplating material to form a colorful electroplated layer.

### BACKGROUND OF THE INVENTION

1. Field of the Invention

The present invention relates generally to a surface layer structure of a silver article and a forming method thereof, and more particularly to a silver metal body with a recrystallized surface layer in the form of 3-dimentional face-centered cubic lattices. The recrystallized surface layer of the silver metal body can reflect light as a diamond.

2. Description of the Related Art

FIG. 1 shows the conventional surface treatment for a silver article. In general, a silver metal body 10 is polished to create a polished surface 101. Alternatively, the silver metal body 10 can go through hair-line surface treatment or drill cut to create fine hair lines or drill cut stripes 102 on the surface of the silver metal body 10. Alternatively, the silver metal body 10 can go through etching or sand-blasting to form an etched surface or a fine sandpit surface 103. By means of different processing processes, the silver metal body 10 can provide different surface effects to satisfy different requirements. In the above processing processes, the surface state of the silver metal body 10 is ruined in the mechanical processing process or by the mechanical agents for creating a metal surface radiance or surface quality and visual effect. Although the surface of the metal article can be mechanically processed or etched with chemical agents to create different cut or etched stripes and present special visual effect and quality feeling, the original special visual effect and quality feeling of the metallic face centered cubic lattice surface can be hardly maintained. Under such circumstance, the solid crystallized surface of the metal itself can be hardly utilized to present multidirectional light reflection effect. Accordingly, the magnificent and glaring unique visual effect of the metallic lattices are ruined and wasted.

SUMMARY OF THE INVENTION

It is therefore a primary object of the present invention to provide a surface layer structure of a silver article. The silver article is made of a silver metal body. The silver metal body has a recrystallized surface layer in the form of solid cubic lattices. The recrystallized surface layer of the silver metal body can irregularly reflect light to present specific colorful radiance and achieve various visual demonstration effects for attracting attention of consumers.

It is a further object of the present invention to provide the above surface layer structure of the silver article. After the silver metal body is formed, at least a part of the surface of the silver metal body is heated to a recrystallization temperature to form the recrystallized surface layer in the form of solid cubic lattices. The recrystallized surface layer of the silver metal body can multidirectionally reflect light to present specific colorful metal radiance and achieve various visual demonstration effects so as to promote competitive ability of the product in the market.

To achieve the above and other objects, the silver article of the present invention is made of a silver metal body. After the silver metal body is formed, at least a part of the surface of the silver metal body is heated to a recrystallization temperature, whereby the part of the surface is recrystallized to form a recrystallized surface layer in the form of multidirectional cubic lattices. In comparison with the conventional silver product, the surface layer structure of the silver article of the present invention presents more excellent visual quality feeling and higher valuation.

Furthermore, the recrystallized surface layer of the silver metal body can be further electrolyzed to enhance the clearness and brilliance of the recrystallized surface layer. In addition, a brightener can be added into the electrolytic solution to further enhance the brilliance of the recrystallized surface layer. The recrystallized surface layer can be further electroplated to form an electroplated layer. The material of the electroplated layer can be doped with colored electroplating material (containing metal material). In this case, the recrystallized surface layer can reflect light to present specific colorful radiance and achieve various visual demonstration effects.

The present invention can be best understood through the following description and accompanying drawings, wherein:

### BRIEF DESCRIPTION OF THE DRAWINGS

FIG. 1 is a perspective view of a conventional surface treatment of a silver article with a processed surface;

FIG. 2 is a perspective view of the surface structure of the silver article of the present invention;

FIG. 3 is a perspective view showing an application of the present invention; and

FIG. 4 is a perspective view showing another application of the present invention, in which the silver article has the form of a thin silver sheet.

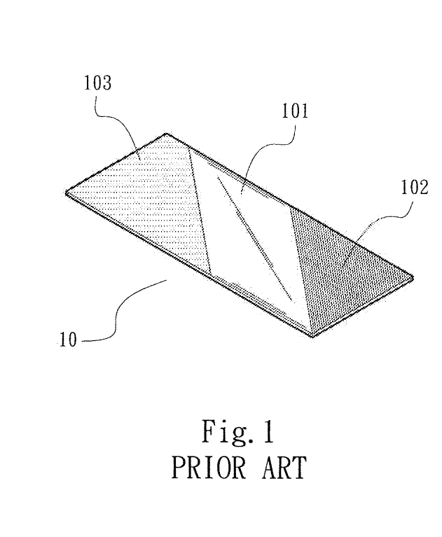

### DETAILED DESCRIPTION OF THE PREFERRED EMBODIMENTS

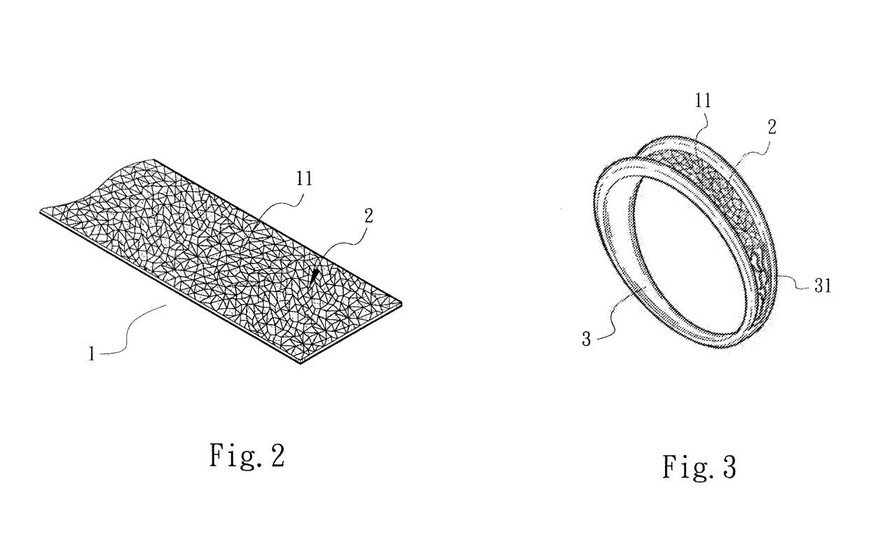

Please refer to FIG. 2. The present invention includes a decoration made of a silver metal body (or silver alloy body) 1 or a silver decoration body with a specific shape such as in the form of a sheet. During the conventional forming process, the silver metal body 1 goes through cold working (such as rolling, forging and extrusion), to cause dense dislocation between the crystalline grains. In this case, the yield strength and tensile strength of the silver metal body 1 are increased, while the malleability is deteriorated. This is adverse to storage of the silver metal body 1. Moreover, residual stresses remain in the silver metal body 1. This is likely to cause unexpected deformation of the silver metal body 1. Furthermore, the surface of the silver metal body 1 often needs to further go through various mechanical processing processes (including rolling, polishing, hair-line surface treatment, drill cut and other surface precision cutting). Under such circumstance, the lattices of the surface of the silver metal body 1 are also ruined. In this case, the original special crystalline visual quality feeling of the surface of the silver metal body 1 cannot be presented. According to the present invention, after the silver metal body 1 is formed, at least a part of the surface of the silver metal body 1 is heated to a recrystallization temperature, whereby the part of the surface is recrystallized to form a recrystallized surface layer 11 in the form of multidirectional cubic lattices. The recrystallized surface layer 11 contains newly growing crystalline grains with small amount of dislocation. Therefore, most of the dislocation can be eliminated. That is, the yield strength and tensile strength of the silver metal body 1 are decreased, while the malleability is enhanced. Also, the residual stresses are reduced. Moreover, the recrystallized surface layer 11 of the silver metal body 1 can irregularly reflect light (crystal flash) as the solid lattice of a diamond. Furthermore, the recrystallized surface layer 11 of the silver metal body 1 can be further electrolyzed to enhance the clearness and brilliance of the recrystallized surface layer 11. In addition, a brightener (or radiance material) can be properly added into the electrolytic solution to further enhance the reflection effect (brilliance) of the recrystallized surface layer 11.

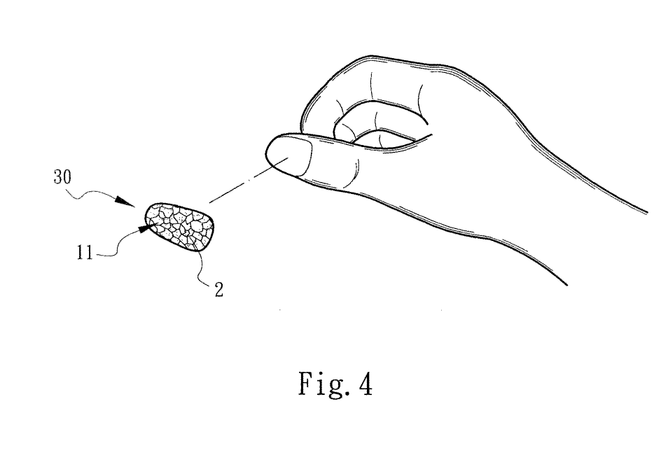

Referring to FIGS. 3 and 4, as necessary, the silver metal body can be formed into a ring-shaped or any otherwise shaped silver decoration 3 such as the ring as shown in FIG. 3 or any other jewelry. Alternatively, the silver metal body can be applied to a surface of a wearable or non-wearable article, such as a watchband, a decoration and a frame body. In the processing, the surface of the silver decoration 3 is first heated to the recrystallization temperature to form the recrystallized surface layer 11. The other part free from the recrystallized surface layer 11 can be processed to form other plane or recessed/raised decorative stripes 31. The recrystallized surface layer 11 can be further coated with an electroplating layer 2. Alternatively, the silver metal body with the recrystallized surface layer 11 can be processed such as rolled to form a thin silver decoration sheet 30 (such as the fake fingernail as shown in FIG. 4 or a decorative face of a watch or a clock). The recrystallized surface layer 11 of the silver decorative sheet 30 can be further rolled into a flattened recrystallized surface layer 11A in the form of scales. Moreover, in order to fully protect the recrystallized surface layer 11 from oxidation or sulfuration, the recrystallized surface layer 11 can be further electroplated to form an electroplated layer 2. In addition, the material of the electroplated layer 2 can be doped with colored electroplating material (containing metal material). In this case, the electroplated layer 2 can irregularly reflect light to present specific colorful radiance and achieve various visual demonstration effects. In comparison with the conventional silver product, the surface layer structure of the silver article of the present invention has more excellent quality and higher valuation.

In conclusion, the surface layer structure of the silver article of the present invention has a recrystallized surface layer, which is truly able to irregularly reflect light to enhance brilliance of the silver article.

The above embodiments are only used to illustrate the present invention, not intended to limit the scope thereof. Many modifications of the above embodiments can be made without departing from the spirit of the present invention.

What is claimed is:

1. A surface layer structure of a silver article comprising a silver metal body, at least a part of the surface of the silver metal body being formed with a recrystallized surface to present lattice visual effect.

2. The surface layer structure of the silver article as claimed in claim 1, wherein the recrystallized surface is further electrolyzed to form an electrolyzed surface.

3. The surface layer structure of the silver article as claimed in claim 1, wherein the recrystallized surface is further electroplated to form an electroplated layer.

4. The surface layer structure of the silver article as claimed in claim 2, wherein the recrystallized surface is further electroplated to form an electroplated layer.

5. The surface layer structure of the silver article as claimed in claim 3, wherein the electroplated layer has a color.

6. The surface layer structure of the silver article as claimed in claim 3, wherein the electroplated layer has a color and is made of a metal material.

7. The surface layer structure of the silver article as claimed in claim 1, wherein the silver metal body has the form of a jewel.

8. The surface layer structure of the silver article as claimed in claim 2, wherein the silver metal body has the form of a jewel.

9. The surface layer structure of the silver article as claimed in claim 3, wherein the silver metal body has the form of a jewel.

10. The surface layer structure of the silver article as claimed in claim 5, wherein the silver metal body has the form of a jewel.

11. The surface layer structure of the silver article as claimed in claim 1, wherein the silver metal body has the form of a sheet body.

12. The surface layer structure of the silver article as claimed in claim 2, wherein the silver metal body has the form of a sheet body.

13. The surface layer structure of the silver article as claimed in claim 11, wherein the sheet body has a surface in the form of flattened scales.

14. The surface layer structure of the silver article as claimed in claim 3, wherein the silver metal body has the form of a sheet body.

15. The surface layer structure of the silver article as claimed in claim 5, wherein the silver metal body has the form of a sheet body.

16. The surface layer structure of the silver article as claimed in claim 7, wherein the silver metal body has the form of a sheet body.

17. The surface layer structure of the silver article as claimed in claim 1, wherein the silver metal body is a decorative face of a clock or a watch.

18. The surface layer structure of the silver article as claimed in claim 2, wherein the silver metal body is a decorative face of a clock or a watch.

19. The surface layer structure of the silver article as claimed in claim 3, wherein the silver metal body is a decorative face of a clock or a watch.

20. The surface layer structure of the silver article as claimed in claim 1, wherein the silver metal body is a watchband.

21. The surface layer structure of the silver article as claimed in claim 2, wherein the silver metal body is a watchband.

22. The surface layer structure of the silver article as claimed in claim 3, wherein the silver metal body is a watchband.

23. The surface layer structure of the silver article as claimed in claim 1, wherein the silver metal body is a surface of a decoration.

24. The surface layer structure of the silver article as claimed in claim 2, wherein the silver metal body is a surface of a decoration.

25. The surface layer structure of the silver article as claimed in claim 3, wherein the silver metal body is a surface of a decoration.

26. The surface layer structure of the silver article as claimed in claim 1, wherein the silver metal body is a surface of a frame body.

27. The surface layer structure of the silver article as claimed in claim 2, wherein the silver metal body is a surface of a frame body.

28. The surface layer structure of the silver article as claimed in claim 3, wherein the silver metal body is a surface of a frame body.

29. A method for forming a surface layer of a silver article, comprising a step of heating at least a part of a surface of a silver metal body to a recrystallization temperature, whereby the part of the surface is recrystallized to form a lattice surface.

30. The method for forming the surface layer of the silver article as claimed in claim 29, wherein the lattice surface is further electrolyzed with an electrolytic solution.

31. The method for forming the surface layer of the silver article as claimed in claim 29, wherein the lattice surface is further electroplated with an electroplating material to form an electroplated layer.

32. The method for forming the surface layer of the silver article as claimed in claim 30, wherein the lattice surface is further electroplated with an electroplating material to form an electroplated layer.

33. The method for forming the surface layer of the silver article as claimed in claim 31, wherein the electroplating material has a color,

34. The method for forming the surface layer of the silver article as claimed in claim 32, wherein the electroplating material has a color.

35. The method for forming the surface layer of the silver article as claimed in claim 31, wherein the electroplating material is a metal material.

36. The method for forming the surface layer of the silver article as claimed in claim 33, wherein the electroplating material is a metal material.

37. The method for forming the surface layer of the silver article as claimed in claim 30, wherein a brightener is added into the electrolytic solution.
